(19) United States
(12) Patent Application Publication
(10) Pub. No.: US 2006/0038107 A1
(43) Pub. Date: Feb. 23, 2006

(54) Bulkheads and methods of fabricating a panel with a mitered corner

(76) Inventor: Kyozaburo Takagi, Centerville, OH (US)

Correspondence Address: DINSMORE & SHOHL LLP;One Dayton Centre, Suite 11300, One South Main Street, Dayton, OH, 45402-2023, US

(21) Appl. No.: 10/922,523

(22) Filed: Aug. 20, 2004

(51) Int. Cl. B28B 7/28; E04G 9/00

(52) U.S. Cl. 249/177; 249/189

(57) ABSTRACT

The present invention relates to bulkheads and brackets for use a part of a bulkhead. The bulkhead includes an upstanding portion including a bracket-mounting end, a mitering portion including a bracket-engaging end, and a bracket including a seat cavity adapted to receive the bracket-engaging end of the mitering portion. The bracket is configured to orient the mitering portion at an acute angle with respect to the upstanding portion with the bracket-engaging end of the mitering portion adjacent the bracket-mounting end of the upstanding portion. Methods are also provided that comprise the steps of arranging a plurality of upstanding portions to define a casting area, pouring uncured precast material into the casting area, and curing the precast material to provide a panel with a mitered corner. In accordance with 37 CFR 1.72(b), the purpose of this abstract is to enable the United States Patent and Trademark Office and the public generally to determine quickly, from a cursory inspection, the nature and gist of the technical disclosure. The abstract will not be used for interpreting the scope of the claims.

### FIELD OF THE INVENTION

The present invention is directed to bulkheads and methods of fabricating a panel with a mitered corner. More specifically, this invention relates to bulkheads and methods of fabricating a panel with a mitered corner from a precast material in order to fabricate a cured panel.

### BACKGROUND OF THE INVENTION

Many residential and commercial construction methods involve the use of pre-cast tilt-up panels to construct structural walls. In order to fabricate the pre-cast tilt-up panels, concrete forms, such as bulkheads, are arranged on a flat casting surface to provide a casting area in the shape and dimension of the desired tilt-up panel. The casting area is then typically filled with concrete and thereafter allowed to cure in the shape of the casting area. Once the concrete cures, the tilt-up panel and the form are separated and the panel is tilted up into a typically vertical orientation where it can be joined to structural frames or other tilt-up panels to provide the desired structural wall configuration.

There is a need for bulkheads, including bulkhead components, configured to facilitate assembly and maintenance of the bulkhead components with respect to on another and to provide methods of fabricating a panel with a mitered corner with desired characteristics.

### BRIEF SUMMARY OF THE INVENTION

This need is met by the present invention wherein improvements in bulkhead, various components of bulkheads, and methods of fabricating a panel with a mitered corner are introduced. In accordance with one embodiment of the present invention, a bulkhead for fabricating a panel with a mitered corner is provided. The bulkhead includes an upstanding portion including a bracket-mounting end, a mitering portion including a bracket-engaging end, and a bracket including a seat cavity adapted to receive the bracket-engaging end of the mitering portion. The bracket is configured to orient the mitering portion at an acute angle with respect to the upstanding portion with the bracket-engaging end of the mitering portion adjacent the bracket-mounting end of the upstanding portion.

In accordance with another embodiment of the present invention, a bracket is provided that is adapted to orient a mitering portion and an upstanding portion of a bulkhead at an acute angle with respect to one another. The bracket includes a first portion with a first surface adapted to engage an upstanding portion of a bulkhead, and a second portion offset from the first portion to at least partially define a seat cavity. The seat cavity is adapted to receive an end of a mitering portion of a bulkhead and orient a mitering portion and upstanding portion of a bulkhead at an acute angle with respect to one another.

In accordance with yet another embodiment of the present invention, a method of fabricating a panel with a mitered corner is provided. The method comprises the steps of arranging a plurality of upstanding portions to define a casting area, engaging a bracket with a selected one of the upstanding portions. The method further includes the steps of inserting a bracket-engaging end of a mitering portion in a seat cavity of the bracket to facilitate maintenance of an acute angular orientation between the mitering portion and the selected upstanding portion and to further define the casting area. The method also comprises the steps of pouring uncured precast material into the casting area, and curing the precast material to provide a panel with a mitered corner.

Accordingly, it is an aspect of the present invention to provide improvements to bulkheads, various components of bulkheads, and methods of fabricating a panel with a mitered corner. Other aspects of the present invention will be apparent in light of the description of the invention embodied herein.

### BRIEF DESCRIPTION OF THE DRAWINGS

The following detailed description of specific embodiments of the present invention can be best understood when read in conjunction with the following drawings, where like structure is indicated with like reference numerals and in which:

FIG. 1 is a partial sectional view of a bulkhead in accordance with one embodiment of the present invention;

FIG. 2 is an enlarged view of portions of the bulkhead taken at view 2 of FIG. 1;

FIG. 3 is a partial sectional view of a panel structure including panels fabricated with the bulkhead of FIG. 1;

FIG. 4 is a partial sectional view of a bulkhead in accordance with a second embodiment of the present invention;

FIG. 5 is an enlarged view of portions of the bulkhead taken at view 5 of FIG. 4;

FIG. 6 is a partial sectional view of a panel structure including panels fabricated with the bulkhead of FIG. 4; and

FIG. 7 is a perspective view of an exemplary casting structure with portions of an upstanding portion being removed to reveal the profile of the bulkhead of FIG. 4 with respect to the remaining casting structure.

The embodiments set forth in the drawing are illustrative in nature and are not intended to be limiting of the invention defined by the claims. Moreover, individual features of the drawing and the invention will be more fully apparent and understood in view of the detailed description.

### DETAILED DESCRIPTION

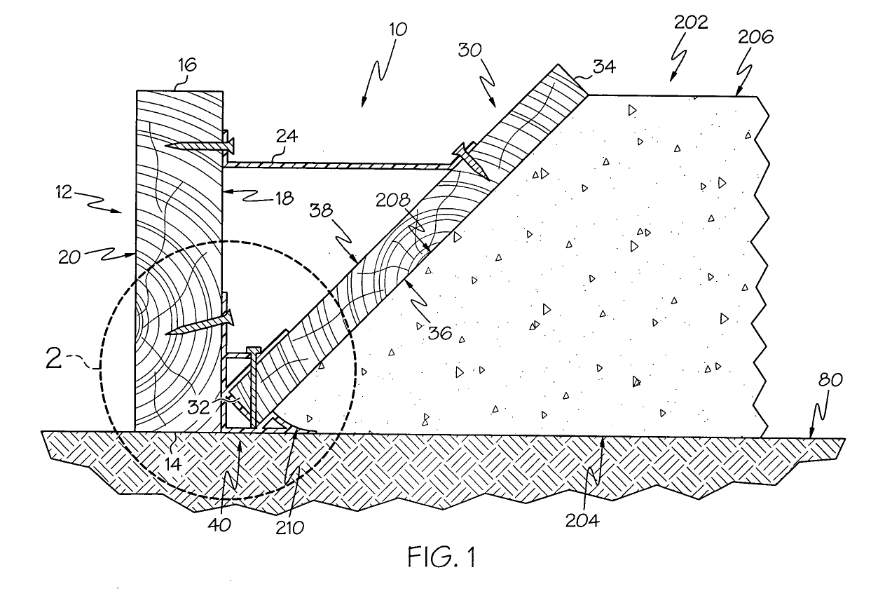

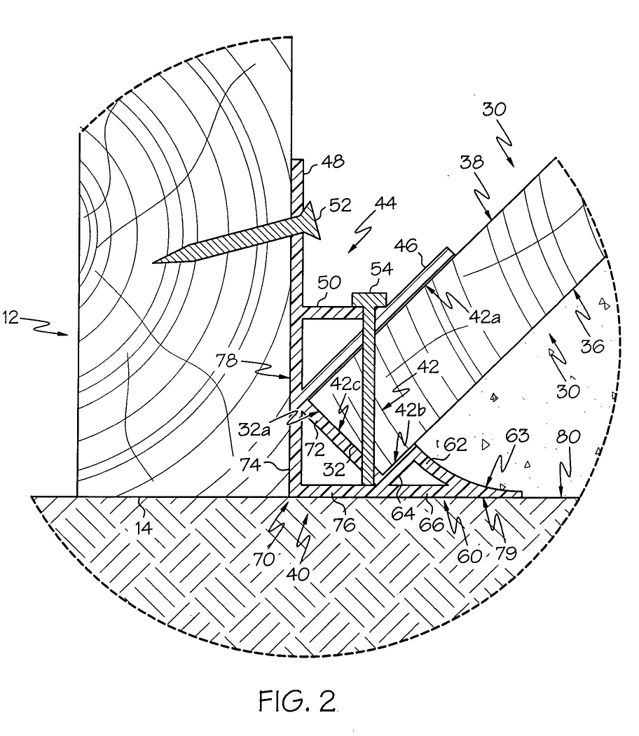

FIGS. 1 and 2 depict an exemplary bulkhead 10 in accordance with one embodiment of the present invention. The bulkhead 10 includes an upstanding portion 12 including a bracket-mounting end 14 and may include another end 16 disposed on an opposite end of the upstanding portion 12. The upstanding portion 12 further includes an upstanding face 18 and might further include another face 20 on an opposite side of the upstanding portion 12. As shown in FIG. 1, one exemplary upstanding portion 12 might comprise a rectangular cross section. However, the upstanding portion 12 might have a wide variety of configurations and/or cross sectional shapes. For example, the upstanding portion 12 might comprise any polygonal cross sectional shape with three or more sides. Still further, the upstanding portion 12 might include a circular or other cross sectional shape. The upstanding face 18 of the upstanding portion 12 can also include numerous shapes and sizes and can be oriented a wide range of angles with respect to a support surface 80. In one embodiment, the upstanding face 18 comprises a substantially planar face that is oriented at approximately 90° with respect to the support surface 80. The upstanding portion 12 may also be formed from varous materials that are sufficient to provide structural integrity to the bulkhead 10. The upstanding portion might comprise wood, metal, plastic, paper products, composites or the like.

The bulkhead 10 further comprises a mitering portion 30 including a bracket-engaging end 32 and might include another end 34 disposed on an opposite end of the mitering portion 30. The mitering portion further includes a first face 36 and might further include another face 38 on an opposite side of the mitering portion 30. As shown, the mitering portion 30 can comprise a panel with a substantially rectangular-shaped cross section. However, the mitering portion 30 might have a wide variety of configurations and/or cross sectional shapes. For example, the mitering portion 30 might comprise any polygonal cross sectional shape with three or more sides. Still further, the mitering portion 30 might include a circular or other cross sectional shape. The first face 36 of the mitering portion 30 can also include a wide variety of shapes, sizes and/or surface textures. In one embodiment, the first face 36 comprises a substantially planar face that might include a substantially smooth planar face. The mitering portion 30 may also be formed from a wide range of materials that are sufficient to resist deformation during lateral loading of the mitering portion in use. For example, the mitering portion 30 might comprise wood, metal, plastic, paper products, composites or the like.

The bulkhead 10 further includes a bracket 40 including a seat cavity 42 adapted to receive the bracket-engaging end 32 of the mitering portion 30. The bracket 40 might be configured to orient the mitering portion 30 at an acute angle with respect to the upstanding portion 12, with the bracket-engaging end 32 of the mitering portion 30 being adjacent the bracket-mounting end 14 of the upstanding portion 12. As shown, the bracket 40 can be configured to orient the mitering portion 30 at a 45° angle with respect to the upstanding portion 12. In alternative embodiments the bracket 40 may be configured to provide any range of acute angles. Still further, as shown, the bracket 40 might be configured with a fixed seat 42 to provide a predetermined angular relationship between the mitering portion 30 and the upstanding portion 12. Although not illustrated, the seat may be adjustable to allow the bracket 40 to provide alternative configurations to facilitate a wide range of predetermined angular relationships between the mitering portion 30 and the upstanding portion 12.

FIG. 2 depicts an enlarged view of portions of FIG. 1, taken at view 2 of FIG. 1. As shown, the bracket 40 can include a first portion 44 including a face 78, such as an upstanding face, for mounting with respect to the bracket-mounting end 14 of the upstanding portion 12. The bracket 40 can also include a second portion 60 that can be offset from the first portion 44 to at least partially define the seat cavity 42. As described above, the seat cavity 42 is adapted to receive the bracket-engaging end 32 of the mitering portion 30. For example, the first portion 44 can include a first seat surface 42a adapted to engage the face 38 of the mitering portion 30 while the second portion 60 can include a second seat surface 42b adapted to engage the first face 36 of the mitering portion 30. In particular embodiments, the first seat surface 42a and the second seat surface 42b are substantially planar seat surfaces that are substantially parallel with respect to one another. In addition, the first face 36 and the second face 38 of the mitering portion 30 might each comprise a substantially planar face that are substantially parallel with respect to one another. Providing the bracket 40 with first and second seat surfaces 42a, 42b that are substantially parallel planar seat surfaces and providing a mitering portion 30 with first and second faces 36, 38 as substantially parallel planar faces may allow quick assembly and breakdown of the bulkhead components. Moreover, providing substantially planar surfaces/faces permits accurate and precise orientation between the mitering portion 30 and the upstanding portion 12. Although not shown, the first and second seat surfaces 42a, 42b might include nonplanar seat surfaces and/or the first and second seat surfaces 42a, 42b might comprise a wide range of shapes, sizes, surface conditions, etc. that facilitate function of the bracket 40. For example, the first and/or second seat surfaces 42a, 42b might include a cleating arrangement, friction surface, scored surface or other arrangement that is adapted to facilitate reception of the bracket-engaging end 32 in the seat cavity 42 and/or that is adapted to maintain the desired acute angle between the upstanding portion 12 and the mitering portion 30.

Brackets in accordance with the present invention are adapted to simultaneously engage the support surface 80 and the upstanding portion. For example, as shown in FIG. 2, the first portion 44 includes a first abutment surface 78 (e.g., upstanding face) adapted to engage the upstanding portion 12 while the second portion 60 includes a second abutment surface 79 (e.g., support surface face) adapted to engage the support surface 80. In further examples, the first abutment surface 78 and second abutment surface 79 are perpendicular with respect to one another. In still further embodiments, the first and second abutment surfaces 78,79 comprise substantially planar surfaces that are substantially perpendicular with respect to one another.

As shown, the bracket can further include a third portion 70 that can connect the first portion 44 to the second portion 60 and can provide a third seat surface 42c adapted to provide a registration stop for the mitering portion 30 to thereby limit insertion of the bracket-engaging end 32 within the seat cavity 42. In one example, the third seat surface 42c comprises a planar surface that engages a planar end surface 32a of the bracket-engaging end 32 of the mitering portion 30.

Brackets throughout this application might comprise a wide variety of structural shapes and may be formed by a wide variety of methods. In one example, the bracket might include one or more chambers to reduce material costs and the weight of the bracket. As shown in FIG. 2, for example, each of the first, second and third portions 44, 60, 70 comprise a chamber defined by a plurality of walls. As shown in FIG. 2, the chamber of the first portion 44 is defined by a first wall 46, a second wall 48 and a third wall 50 wherein the first wall 46 provides the first seat surface 42a, the second wall 48 provides the first abutment surface 78 and the third wall 50 acts as a reinforcement structure extending between the first and second walls.

Still further, the chamber of the second portion 60 is defined by a first wall 62, a second wall 64 and a third wall 66 wherein the first wall 62 provides the concave surface 63, the second wall 64 provides the second seat surface 42b and the third wall 66 provides the second abutment surface 79. The chamber of the third portion 70 is defined by a first wall 72, a second wall 74 and a third wall 76 wherein the first wall 72 provides the third seat surface 42c, the second wall 74 provides another abutment surface to engage with the upstanding portion and the third wall 76 provides yet another abutment surface adapted to engage the support surface 80.

The brackets illustrated throughout this application can have an elongated length and a substantially uniform cross section along substantially the entire elongated length. For example, as shown in FIG. 7, the illustrated bracket includes an elongated length “L” and a substantially uniform cross section along substantially the entire elongated length “L” of the bracket. While a wide variety of methods of fabricating a bracket with a substantially uniform cross section might be used, the embodiments of the present invention might include a bracket formed with an extrusion process to provide a substantially uniform cross section along substantially the entire elongated length of the bracket. Insignificant variations in the uniformity of the cross section due to fabrication process errors or post fabrication process steps are contemplated. For example, holes may be drilled in an extruded member in specific locations after the member is extruded. Similarly, cuts or cutouts may be formed in the extruded member after it is extruded.

As shown throughout the figures, structures may also be provided to assist in maintaining the bracket-engaging end of the mitering portion within the seat cavity of the bracket. For example, with reference to FIGS. 1 and 2, a bolt 54 or other fastener might be used to arrest the bracket-engaging end 32 of the mitering portion 30 within the seat cavity 42 of the bracket 40. A screw 52 or other fastener might also be used to mount the bracket with respect to the upstanding portion 12. It is contemplated that other fasteners or fastening arrangements might be provided. For example, staples, set screws, or the like might be used in accordance with the principles of the present invention. Still further, double sided tape, adhesives (e.g., epoxy adhesives) or other fastening arrangements might be used to attach the components relative to one another.

As further shown throughout the figures, structures may also be provided to assist in maintaining the mitering portion in an appropriate orientation with respect to the upstanding portion. As shown in FIG. 1, for example, a cross brace 224 may be provided between the mitering portion 30 and the upstanding portion 12 to assist in providing a rigid bulkhead structure and also assist in maintaining the orientation of the mitering portion with respect to the upstanding portion when pouring uncured precast material into a casting area of a casting structure.

A method of using the bulkhead of FIGS. 1-2 to fabricate a panel with a mitered corner will now be discussed. With reference to FIG. 7, a casting structure 400 can be formed with a pair of apposed bulkheads 10. A first lateral upstanding portion 402 and second lateral upstanding portion 404 may be attached with fasteners 406 to upstanding portions 12 located on opposite sides of the casting structure 400. The bracket 40 is then engaged with a selected one of the upstanding portions. For example, the bracket 40 can be placed adjacent the bracket-mounting end 14 of the upstanding portion 12 and then fastened into place. A bracket-engaging end of the mitering portion 30 is then inserted into the seat cavity 42 of the bracket 40 to facilitate maintenance of an acute angular orientation between the mitering portion and the upstanding portion 12. As shown in FIG. 7, a pair of opposed bulkheads might be provided for applications where the panel includes two mitered corners.

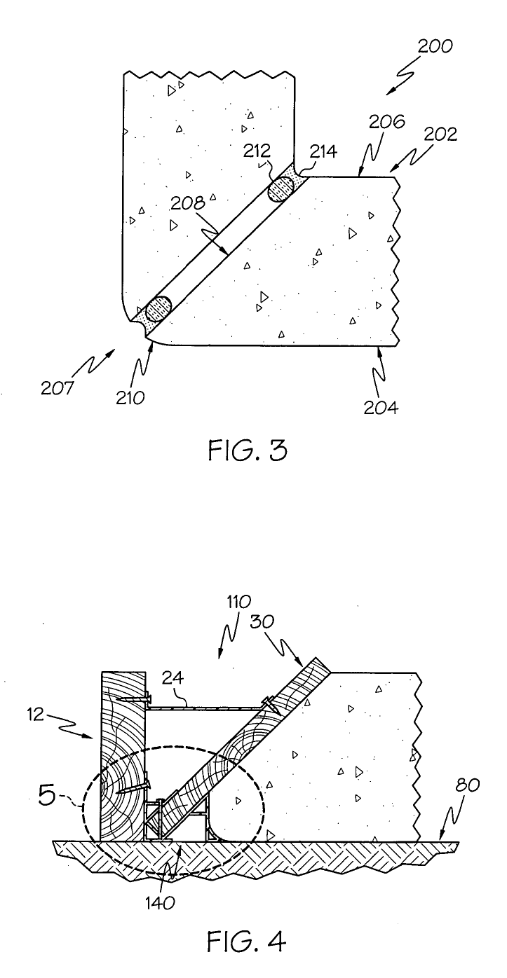

Once the casting structure 400 is formed, the uncured precast material is poured into the casting area. As shown in FIG. 1, the material flows laterally to engage the first face 36 of the mitering portion 30 and the curved surface 63 of the second portion 60. As shown in FIG. 3, a panel is therefore formed with a mitered corner 207 including a mitered surface portion 208 and a curved surface 210 extending from the mitered surface portion. As further illustrated in FIG. 3, a plurality of panels 202 might be coupled together at each panels respective mitered corners 207 to form a panel structure 200. In one particular embodiment, one or more gaskets 212 are placed between the mitered surface portions 208 and a sealing layer 214 might be used to inhibit liquid from entering into the mitered joint of the panel structure 200.

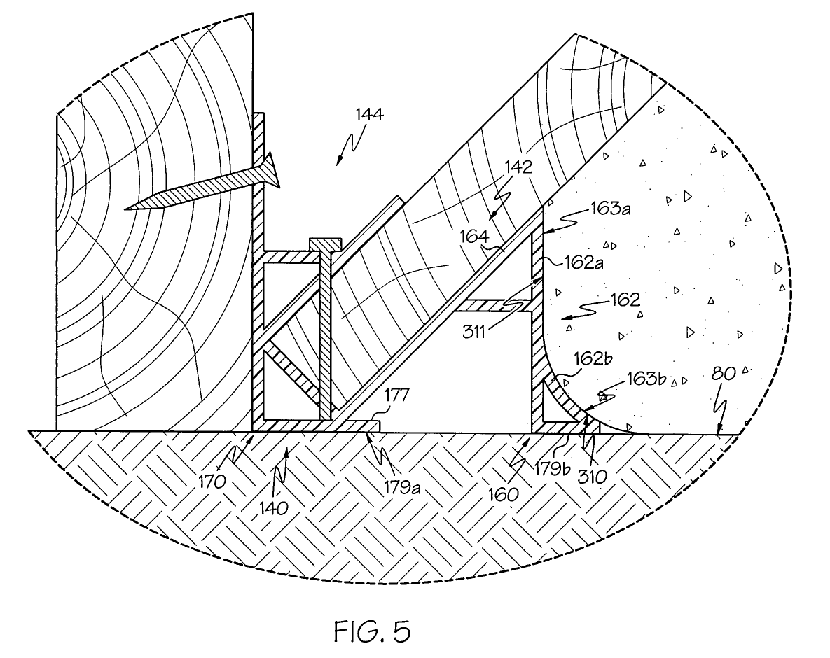

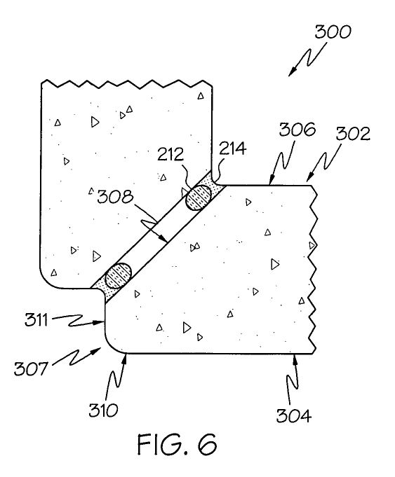

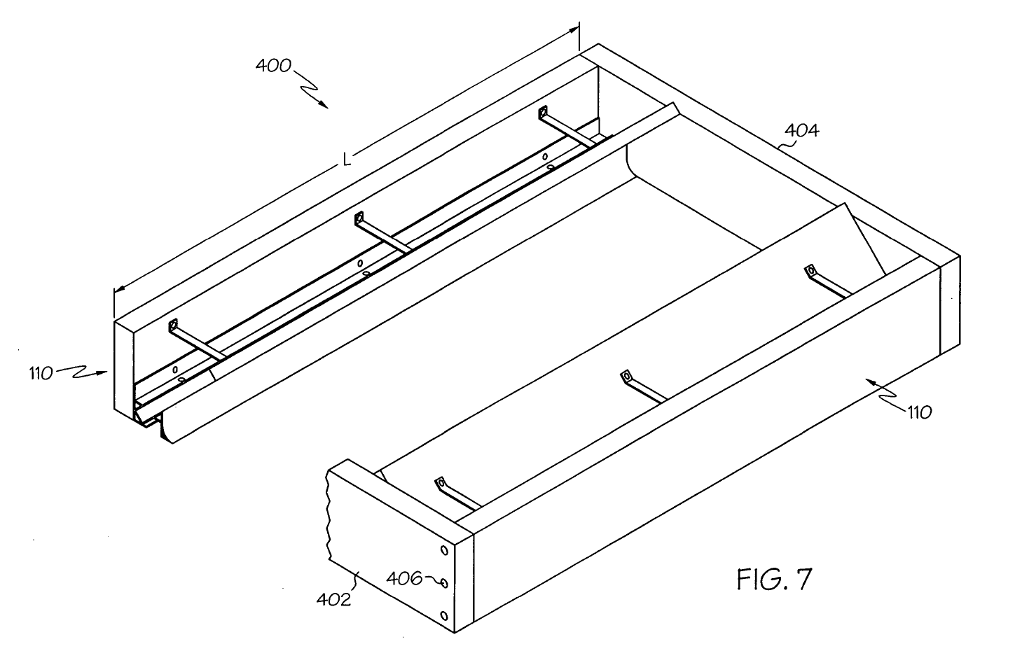

FIGS. 4 and 5 depict an alternative bulkhead 110 in accordance with the present invention wherein like reference numbers designate similar elements throughout the views. As shown in FIG. 4, the bulkhead 110 can be constructed similar to the bulkhead 10 as described above. However, a modified bracket 140 can be used to create different mitered corner surface characteristics. As shown in FIG. 5, the bracket 140 includes a first portion 144 that is similar to the first portion 44 of bracket 40. Likewise, bracket 140 includes a third portion 170 that is similar to the third portion 70 of bracket 40.

However, the second portion 160 of the bracket 140 has been modified to provide different mitered corner characteristics. As shown, the second wall 164 of the second bracket portion 164 has been elongated and provided with a modified first wall 162. The first wall 162 includes a linear portion 162a defining an upstanding planar surface 163a extending from the seat cavity 142 to a concave surface 163b defined by a curved portion 162b of the first wall 162. The second portion 160 further includes first and second support surface faces 179a,179b adapted to engage the support surface 80.

A method of making a panel structure with the bulkhead 110 includes using the bulkhead 110 to form a casting structure 400. Next uncured precast material is poured into the casting area such that the material engages the face 36 of the mitering portion 30, the upstanding planar surface 163a of the bracket 140 and the concave surface 163b of the bracket 140 to provide the mitered corner 307 with a mitered surface portion 308, a planar surface 311 extending from the mitered surface portion 308 and a curved surface 310 extending from the planar surface 311 of the mitered corner 307.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A bulkhead for fabricating a panel with a mitered corner comprising:
an upstanding portion including a bracket-mounting end;
a mitering portion including a bracket-engaging end; and
a bracket including a seat cavity adapted to receive the bracket-engaging end of the mitering portion, the bracket configured to orient the mitering portion at an acute angle with respect to the upstanding portion, with the bracket-engaging end of the mitering portion adjacent the bracket-mounting end of the upstanding portion.

2. The bulkhead of claim 1, wherein the bracket comprises a first portion including an upstanding face mounted with respect to the bracket-mounting end of the upstanding portion and a second portion, wherein the second portion is offset from the first portion to at least partially define the seat cavity.

3. The bulkhead of claim 2, wherein the second portion of the bracket includes a concave surface.

4. The bulkhead of claim 3, wherein the concave surface substantially extends from the seat cavity.

5. The bulkhead of claim 3, wherein the mitering portion includes a first face, and at least a portion of the first face of the mitering portion and the concave surface of the bracket are adapted to form surfaces of a panel.

6. The bulkhead of claim 2, wherein the mitering portion includes a first face and a second face, and the first portion of the bracket includes a first seat surface engaged with the second face of the mitering portion and the second portion of the bracket includes a second seat surface engaged with the first face of the mitering portion.

7. The bulkhead of claim 6, wherein the first and second faces of the mitering portion comprise substantially planar faces that are substantially parallel with respect to one another.

8. The bulkhead of claim 6, wherein the first and second seat surfaces of the bracket comprise substantially planar seat surfaces that are substantially parallel with respect to one another.

9. The bulkhead of claim 2, wherein the second portion of the bracket includes a support surface face oriented substantially perpendicular with respect to the upstanding face of the first portion of the bracket.

10. The bulkhead of claim 2, wherein second portion of the bracket includes an upstanding planar surface adapted to form a planar surface of a panel.

11. The bulkhead of claim 10, wherein the second portion of the bracket includes a concave surface extending from the upstanding planar surface and adapted to form a curved surface of a panel.

12. The bulkhead of claim 10, wherein the second portion of the bracket includes a concave surface and the upstanding planar surface of the second portion of the bracket substantially extends between the seat cavity and the concave surface.

13. The bulkhead of claim 1, wherein the bracket includes an elongated length and a substantially uniform cross section along substantially the entire elongated length of the bracket.

14. A bracket adapted to orient a mitering portion and an upstanding portion of a bulkhead at an acute angle with respect to one another, the bracket comprising:
a first portion including a first surface adapted to engage an upstanding portion of a bulkhead; and
a second portion offset from the first portion to at least partially define a seat cavity adapted to receive an end of a mitering portion of a bulkhead and orient a mitering portion and upstanding portion of a bulkhead at an acute angle with respect to one another.

15. The bracket of claim 14, wherein the bracket comprises an elongated length and a substantially uniform cross section along substantially the entire elongated length of the bracket.

16. The bracket of claim 14, wherein the second portion includes a concave surface.

17. The bracket of claim 16, wherein the concave surface substantially extends from the seat cavity.

18. The bracket of claim 14, wherein the first portion of the bracket includes a first seat surface and the second portion of the bracket includes a second seat surface.

19. The bracket of claim 18, wherein the first and second seat surfaces each comprise a substantially planar surface, and wherein the first and second substantially planar seat surfaces are substantially parallel with respect to one another.

20. The bracket of claim 14, wherein the second portion of the bracket includes a second surface oriented substantially perpendicular with respect to the first surface of the first portion of the bracket.

21. The bracket of claim 14, wherein the second portion of the bracket includes an upstanding planar surface adapted to form a planar surface of a panel.

22. The bracket of claim 21, wherein the second portion of the bracket includes a concave surface extending from the upstanding planar surface and adapted to form a curved surface of a panel.

23. The bracket of claim 21, wherein the second portion of the bracket includes a concave surface and the upstanding planar surface of the second portion of the bracket substantially extends between the seat cavity and the concave surface.

24. A method of fabricating a panel with a mitered corner comprising the steps of:
arranging a plurality of upstanding portions to define a casting area;
engaging a bracket with a selected one of the upstanding portions;
inserting a bracket-engaging end of a mitering portion in a seat cavity of the bracket to facilitate maintenance of an acute angular orientation between the mitering portion and the selected upstanding portion and to further define the casting area;
pouring uncured precast material into the casting area; and
curing the precast material to provide a panel with a mitered corner.

25. The method of claim 24, further comprising the steps of providing the bracket with a concave surface and the step of pouring uncured precast material includes pouring uncured precast material such that the material engages a face of the mitering portion and the concave surface of the bracket to provide the mitered corner with a mitered surface portion and a curved surface extending from the mitered surface portion.

26. The method of claim 24, further comprising the steps of providing the bracket with an upstanding planar surface extending from a face of the mitering portion and a concave surface extending from the upstanding planar surface of the bracket and the step of pouring uncured precast material includes pouring uncured precast material such that the material engages the face of the mitering portion, the upstanding planar surface of the bracket and the concave surface of the bracket to provide the mitered corner with a mitered surface portion, a planar surface extending from the mitered surface portion and a curved surface extending from the planar surface of the mitered corner.
